(19) United States
(12) Patent Application Publication
(10) Pub. No.: US 2016/0230771 A1
(43) Pub. Date: Aug. 11, 2016

(54) Geared Turbomachine

(71) Applicants: Anja Christina DOBAT, Berlin (DE); Ole HANSEN, Hamminkein (DE); Hans-Otto JESKE, Wesel (DE); Markus RÖHNER, Berlin (DE)

(72) Inventors: Anja Christina DOBAT, Berlin (DE); Ole HANSEN, Hamminkein (DE); Hans-Otto JESKE, Wesel (DE); Markus RÖHNER, Berlin (DE)

(21) Appl. No.: 15/014,844

(22) Filed: Feb. 3, 2016

(30) Foreign Application Priority Data
Feb. 6, 2015 (DE) 102015001418.8

(51) Int. Cl. F04D 25/16; F04D 25/04; F04D 29/32; F01D 5/02; F01D 15/10; F04D 29/28

(52) U.S. Cl. CPC F04D 25/163; F01D 15/10; F04D 29/284; F04D 29/321; F01D 5/02; F04D 25/045; F05D 2220/32; F05D 2220/31; F05D 2260/40311

(57) ABSTRACT

A geared turbomachine having a gear unit a drive unit, and output units integrated into a machine train a central large gear with a large gear shaft and at least two pinions with at least two pinion shafts meshing with the large gear. The geared turbomachine has a drive unit coupled to a first pinion shaft of the gear unit via a first clutch. A first output unit is a main compressor processes a first process gas. The first output unit is coupled to the first pinion shaft via a second clutch such that the first output unit is directly operationally connected to the drive unit with transmission of the gear unit remaining the same. A second output unit is a geared compressor to further process the gas. The second output unit is connected to at least one further pinion shaft of the gear unit in a rotationally fixed manner.

### BACKGROUND OF THE INVENTION

1. Field of the Invention

The invention relates to a geared turbomachine.

2. Description of the Related Art

EP 2 128 448 A2 discloses a geared turbomachine with a gear unit, a drive unit, and multiple output units. These components of the geared turbomachine are integrated into a machine train. The gear unit comprises a central large gear with a large gear shaft. Multiple pinions mounted on pinion shafts mesh with the large gear. The drive unit is preferentially a steam turbine. The output units are preferentially compressors, namely a main compressor and multiple geared compressors. According to EP 2 128 448 A2 the drive unit is coupled to a first pinion shaft of the gear unit via a first clutch, whereas the output unit that is designed the as main compressor is coupled to a second pinion shaft of the gear unit via a second clutch, so that the drive unit and the first output unit, which is designed as main compressor, are operationally connected to one another via a transmission stage of the gear unit (rotational speed step-down power gear). The optimal design of such known machine trains from the prior art according to EP 2 128 448 A2 is substantially effected in that the drive and output units are operated in the optimal working range and adaptation with respect to the rotational speeds largely takes place via the transmission ratio in the power gear.

### SUMMARY OF THE INVENTION

There is a need for a geared turbomachine that can be operated more effectively and consequently with reduced losses. There is furthermore a need in reducing the installation space requirement of such a geared turbomachine to be able to position the geared turbomachine in smaller-dimensioned buildings with reduced construction height.

An object of the invention is creating a new type of geared turbomachine. The geared turbomachine according to one embodiment of the invention comprises a gear unit, a drive unit, and multiple output units integrated into a machine train. The gear unit comprises a central large gear with a large gear shaft and at least two pinions with respective pinion shaft meshing with the large gear. The drive unit can be preferentially designed as a steam turbine in which for power steam is expanded to provide mechanical drive. The drive unit is coupled to a first pinion shaft of the gear unit on a side of the gear unit via a first clutch. A first output unit is designed as a main compressor, in which, utilising mechanical drive power provided by the drive unit, a first process gas is compressed. The first drive unit is coupled to the first pinion shaft of the gear unit on the opposite side of the same via a second clutch such that the first output unit with a closed first clutch and a closed second clutch is directly operationally connected to the drive unit with transmission remaining the same (i.e. without a transmission stage) of the gear unit. At least one second output unit is designed as geared compressor in which, utilising mechanical drive power provided by the drive unit, the first or at least one further process gas is compressed. The second output unit is connected in a rotationally fixed manner to a further pinion shaft of the gear unit.

Such a geared turbomachine, in which the drive unit that is preferentially designed as steam turbine is coupled to the first output unit designed as a main compressor directly without a transmission stage of the gear unit of the geared turbomachine, can be operated with higher efficiency or with lower losses than is the case with machine trains known from the prior art.

During the course of the considerations regarding a new concept for a machine train with geared turbomachine and drive and output units it has been established that according to the arrangement principles up to now the optimum for the entire machine train is not achieved for each case of application, in particular with respect to costs and installation space.

In particular through investigations of the gear unit configuration that by omitting a power gear between the drive unit and output unit the gear friction losses and the costs for the gear unit can be significantly reduced and the overall efficiency of the machine train is thus substantially influenced.

Starting out from the objective of minimizing costs, maintaining the compression performance, and also keeping the overall efficiency at least the same, it has unexpectedly been established that a drive unit that is specially designed for the overall process is thus not mandatorily required for achieving the mentioned targets and accordingly the drive unit can be selected less dependent on its rotational speed-optimised working range.

According to one embodiment, the main compressor is designed as radial compressor (preferentially at least two stages), wherein downstream of the front compressor stages, but not the last compressor stage, an intercooler is generally connected to reduce the volume and the temperature of the compressing first process gas. The configuration of the main compressor as radial compressor with intercooling after or between the compressor stages of the radial compressor is advantageous for increasing the efficiency and for reducing the installation space requirement of the geared turbomachine.

According to one embodiment, the main compressor is designed as an axial compressor with at least one radial final stage, wherein downstream after the axial stages and before entering the radial final stage intercooling is connected.

Optionally, an axial compressor with two radial final stages is also possible; in this case intercooling between the two radial stages is also possible.

According to one embodiment, the drive unit, which is designed as steam turbine, comprises an axial exhaust steam casing, wherein a condenser of the drive unit designed as steam turbine is positioned on separate supports seen in the direction of a longitudinal axis of the steam turbine next to a foundation table supporting the steam turbine. Through this configuration it is not necessary to position the condenser below the foundation table. The condenser is rather arranged next to the foundation table on separate supports. This is advantageous in particular for reducing the installation space requirement since by doing so the height of the foundation table can be reduced for example from up to approximately 12 m to approximately 4 m and the construction height of the entire geared turbomachine thereby reduced. Furthermore it is thus possible to embody the machine foundation thinner or lighter.

According to one embodiment, the geared turbomachine comprises two to eight second output units designed as geared compressors. When the geared turbomachine comprises two geared compressors the same are connected to the second pinion shaft in a rotationally fixed manner. When the geared turbomachine comprises three or four geared compressors, the same are connected to a further pinion shaft in a rotationally fixed manner, wherein in particular when the geared turbomachine comprises five or six geared compressors, the same are connected to yet a further pinion shaft in a rotationally fixed manner, and in particular when the geared turbomachine comprises seven or eight geared compressors, the same are yet gain connected to a further pinion shaft in a rotationally fixed manner. By way of the selection of a suitable number of geared compressors the efficiency can be further increased.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail with the help of the drawing without being restricted to this. It shows:

FIG. 1a is a block diagram of a first geared turbomachine according to the invention;

FIG. 1b is a schematic, perspective view of a gear unit of the geared turbomachine according to FIG. 1a;

FIG. 2a is a block diagram of a second geared turbomachine according to the invention;

FIG. 2b is a schematic, perspective view of a gear unit of the geared turbomachine according FIG. 2a;

FIG. 3a is a block diagram of a third geared turbomachine according to the invention;

FIG. 3b is a schematic, perspective view of a gear unit of the geared turbomachine according FIG. 3a;

FIG. 4a is a block diagram of a fourth geared turbomachine according to the invention;

FIG. 4b is a schematic, perspective view of a gear unit of the geared turbomachine according FIG. 4a;

FIG. 5a is a block diagram of a fifth geared turbomachine according to the invention;

FIG. 5b is a schematic, perspective view of a gear unit of the geared turbomachine according FIG. 5a;

FIG. 6a is a block diagram of a sixth geared turbomachine according to the invention;

FIG. 6b is a schematic, perspective view of a gear unit of the geared turbomachine according FIG. 6a.

FIG. 7a is a block diagram of a seventh geared turbomachine according to the invention;

FIG. 7b is a schematic, perspective view of a gear unit of the geared turbomachine according FIG. 7a;

FIG. 8a is a block diagram of a eight geared turbomachine according to the invention; and

FIG. 8b is a schematic, perspective view of a gear unit of the geared turbomachine according FIG. 8a.

### DETAILED DESCRIPTION OF THE PRESENTLY PREFERRED EMBODIMENTS

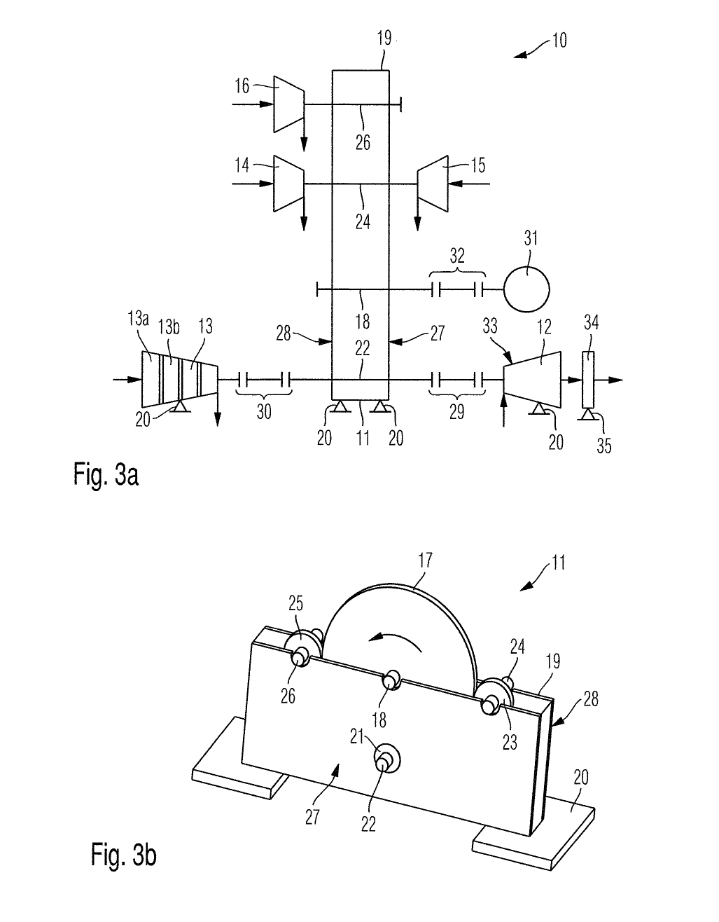

FIGS. 3a and 3b show a preferred exemplary embodiment of a geared turbomachine 10 according to one embodiment the invention. The geared turbomachine 10 comprises an integrated gear unit 11, a drive unit 12, multiple output units 13, 14, 15, and 16, wherein the gear unit 11, the drive unit 12 and the multiple output units 13, 14, 15, and 16 are integrated into a machine train.

The gear unit 11 of the geared turbomachine 10 comprises a large gear 17, which is positioned on a large gear shaft 18 and via the large gear shaft 18 is rotatably mounted in a gear unit housing 19 of the gear unit 11. Multiple pinions 21, 23, 25 mesh with the large gear 17 of the gear unit 11 on the circumference of the large gear 17, which pinions are fastened on pinion shafts 22, 24, 26 and via the pinion shafts 22, 24 and 26 are likewise rotatably mounted in the gear unit housing 19.

In the exemplary embodiment of FIGS. 3a and 3b, a total of three such pinions 21, 23, and 25 mounted on pinion shafts 22, 24, and 26 mesh with the large gear 17 on the circumference of the large gear 17.

The drive unit 12 is designed as steam turbine, in which steam is expanded for providing mechanical drive power. The drive unit 12 is coupled to a first pinion shaft 22 of the gear unit 11, namely on a first side 27 of the gear unit 11 or of the gear unit housing 19, wherein the drive unit 12 which is designed as steam turbine is coupled to the first pinion shaft 22 via a first clutch 29.

The multiple drive units 13, 14, 15, and 16 include a first output unit 13 designed as main compressor and multiple second output units 14, 15, and 16 designed as geared compressors. The main compressor or the first output unit 13 is designed in at least two stages wherein in the main compressor a first process gas is compressed utilizing the mechanical drive power provided by the drive unit 12.

The first output unit 13 or the main compressor is coupled to the first pinion shaft 22 of the gear unit 11, namely on a second side 28 of the gear unit 11 or gear unit housing 19 located opposite the first side 27. Here, the first output unit 13, which is designed as a main compressor, acts via a second clutch 30 on the first pinion shaft 22, to which the drive unit 12 is also coupled via the first clutch 29.

In particular when the first clutch 29 and the second clutch 30 are both closed, the drive unit 12 and the first output unit 13, designed as main compressor, are directly operationally connected to one another with transmission remaining the same and without intermediate connection of a transmission stage of the gear unit 11, so that the same rotate with the same rotational speed.

In addition to the drive unit 12 and the first output unit 13 designed as main compressor, the geared turbomachine 10 of FIG. 3a comprises three second output units 14, 15, and 16, which are designed as geared compressors. In the second output units 14, 15, and 16 designed as geared compressors, the first process gas and/or one or multiple further process gases is/are compressed or further compressed utilising the mechanical drive power provided by the drive unit 12, wherein the second output units 14, 15, and 16 are connected to further pinion shafts 24, 26 of the gear unit 11 in a rotationally fixed manner.

Accordingly, the three further second output units 14, 15, and 16 are connected, in the exemplary embodiment of FIGS. 3a and 3b, to two further pinion shafts 24 and 26 in a rotationally fixed manner namely in such a manner that the two geared compressors 14 and 15 are connected to a second pinion shaft 24 of the gear unit 11 in a rotationally fixed manner on opposite sides 27 and 28 of the gear unit 11 or gear unit housing 19, whereas the geared compressor 16 is connected to a third pinion shaft 26 of the gear unit 11 in a rotationally fixed manner, preferentially in the region of that side 28 of the gear unit housing 19, on which the geared compressor 14 and the main compressor 13 are also positioned.

Of the total power of the machine train, at least 50% is accounted for by the main compressor and the rest (less than 50%) by the geared compressor that makes it clear that the rotational speed-optimised design in particular of the main compressor and of the drive unit 12 is of great important for increasing the effectiveness of the machine train.

In the exemplary embodiment of FIGS. 3 and 3b, the first pinion shaft 22 is positioned approximately in the 6 o'clock position of the large gear 17 and via the pinion 21 meshes with the large gear 17 in this position. The second pinion shaft 24 with the pinion 23 is positioned approximately in the 3 o'clock position and the third pinion shaft 26 with the pinion 25 is positioned approximately in the 9 o'clock position of the large gear 17, these pinions 23 and 25 meshing with the large gear 17 in these positions.

As shown in FIG. 3a, an optional generator 31 or alternatively a motor can be coupled to the large gear shaft 18 of the gear unit 11, namely via a clutch 32.

As already explained, the first output unit 13 designed as main compressor can be designed in multiple stages with multiple compressor stages.

Downstream of the front compressor stage 13a an intercooler 13b is positioned to cool the already compressed fluid, first process gas and by doing so reduce the volume and the temperature of the same. The efficiency of the geared turbomachine can thereby be improved, in particular with a view to further processing the first process gas in the region of the geared compressors 14, 15, or 16.

It is preferentially possible to position an intercooler like 13b for cooling down the respective compressed process gas also downstream of each geared compressor 14, 15, and 16.

The gear unit 11 together with the geared compressors 14, 15, and 16, the drive unit 12 designed as steam turbine and the first output unit 13 designed as main compressor are preferentially mounted on a common foundation table 20 of a machine foundation.

In the region of the steam turbine or of the drive unit 12, an axial exhaust steam casing 33 is employed so that expanded medium leaves the steam turbine 12 in axial direction.

A condenser 34 positioned downstream of the steam turbine 12, seen in the direction of a longitudinal axis of the steam turbine 12, is then preferentially positioned next to the foundation table of the machine foundation supporting the steam turbine 12, namely preferentially on separate supports 35.

The geared turbomachine 10 shown in FIGS. 3a and 3b accordingly comprises the integrated gear unit 11, the drive unit 12 designed as steam turbine, the first output unit 13 designed as main compressor and at least three second output units 14, 15, and 16 designed as geared compressors. According to one embodiment of the invention, the steam turbine 12 and the at least two-stage main compressor 13 are coupled via corresponding clutches 29, 30 to the same pinion shaft 22 of the gear unit 11 so that in particular when the two clutches 29 and 30 are coupled, steam turbine 12 and main compressor 13 without gearing of the gear unit 11 are directly operationally connected with transmission remaining the same and operated with the same rotational speed. Following the passing through of other process steps outside the machine train, the geared compressors 14, 15, and 16 generally serve for the further processing of the process gas compressed in the main compressor 13 and/or for compressing at least one further process gas. The pinion 21 mounted on the first pinion shaft 22 has to transmit the full power of the geared turbomachine 10 or the full drive power of the steam turbine 12. The steam turbine 12 comprises an axial outflow or exhaust steam casing 33, wherein the condenser 34 is positioned next to the foundation table 20 on separate supports 35.

The main compressor 13 is preferably embodied at least in two stages, preferentially as a radial compressor. In the two-stage radial compressor intercoolers are integrated after the front stages. In the geared compressors 14, 15, and 16, the process gas compressed in the main compressor 13 and/or at least one further process gas is/are compressed or further compressed. Downstream of each geared compressor 14, 15, 16, a further intercooler can be preferentially positioned.

The geared turbomachine 10 is preferentially driven via the drive unit 12 designed as steam turbine drives the main compressor 13 directly or indirectly with the same rotational speed through the housing 19 of the gear unit 11. The geared compressors 14, 15, and 16 are likewise driven starting out from the steam turbine 12 or from the drive unit, however with different rotational speeds and namely with an optimal rotational speed for the respective geared compressor that is dependent on the specific transmission ratio of the gear unit 11.

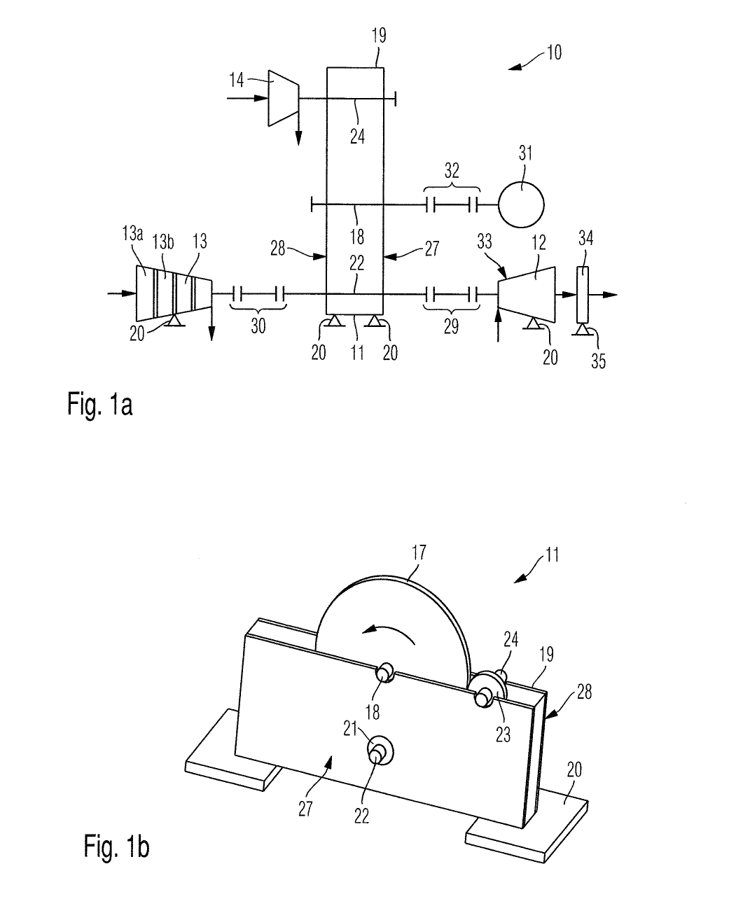

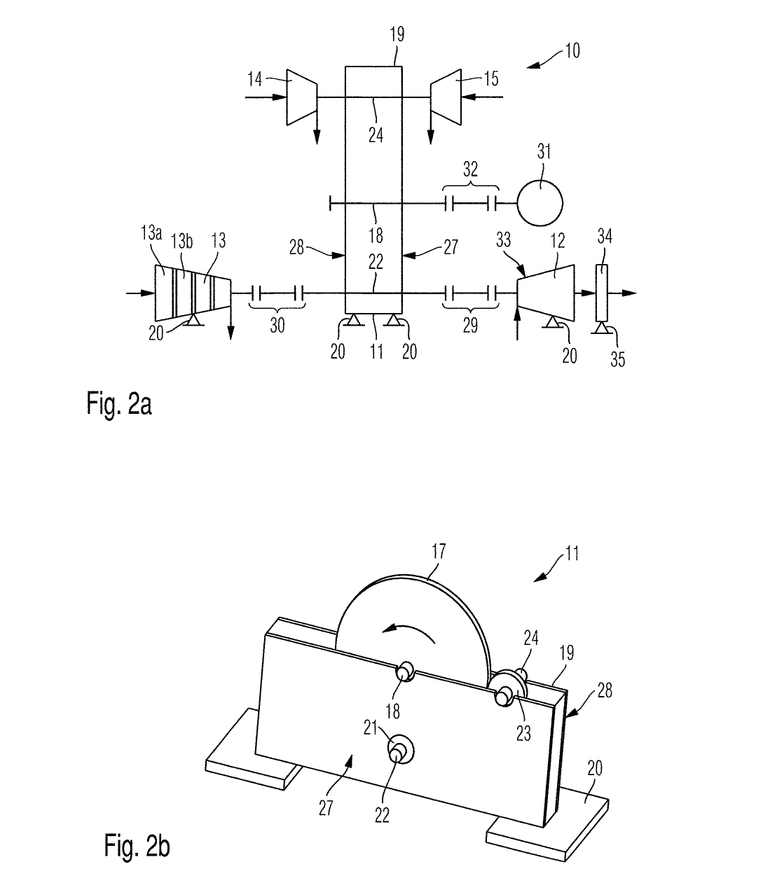

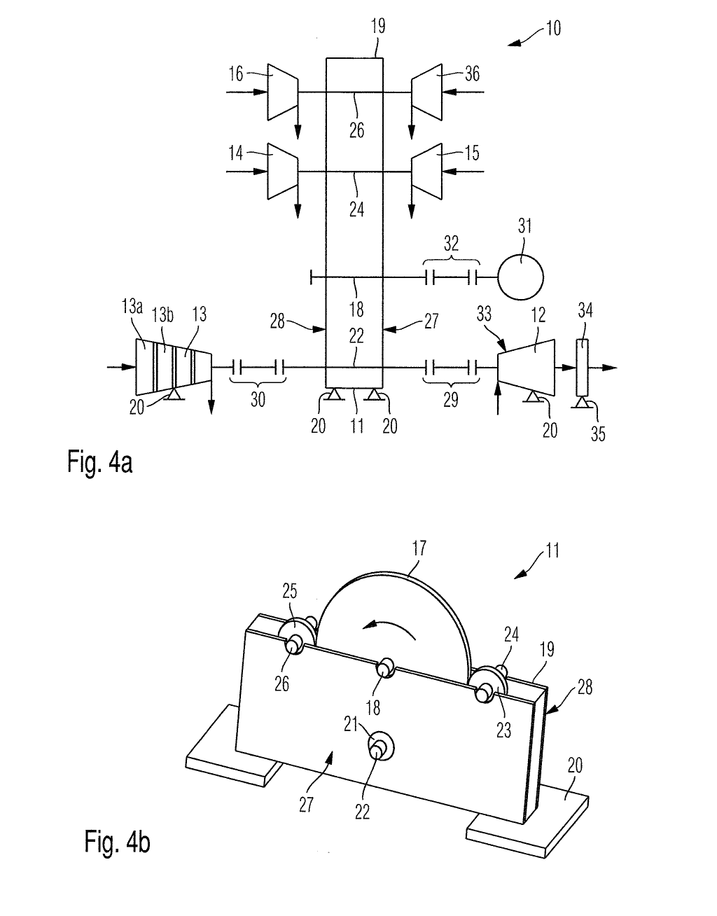

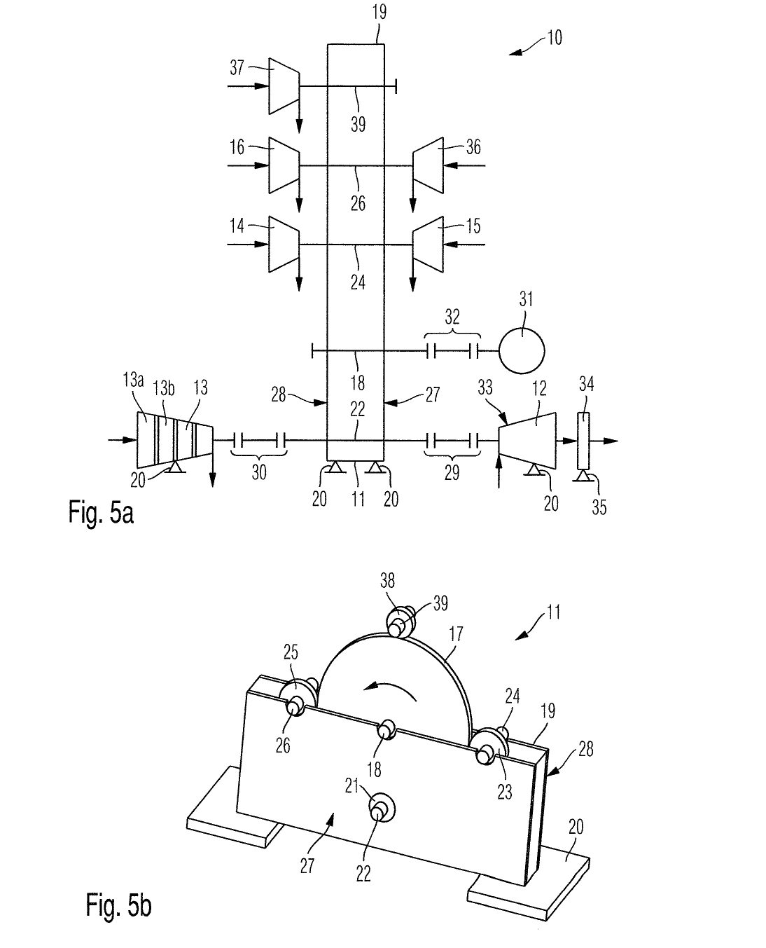

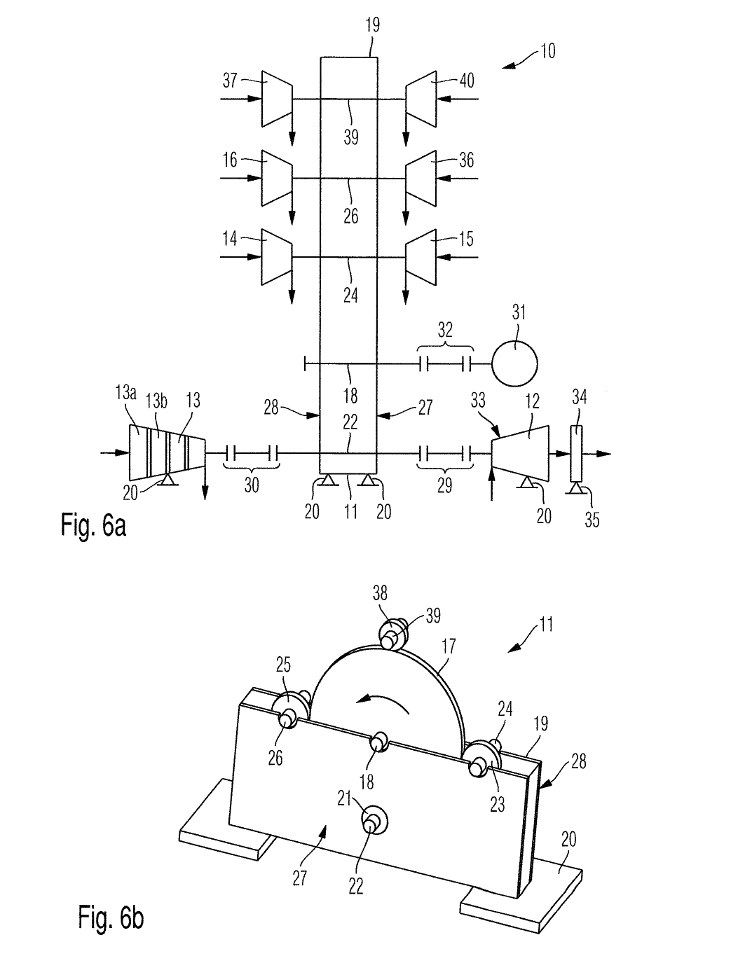

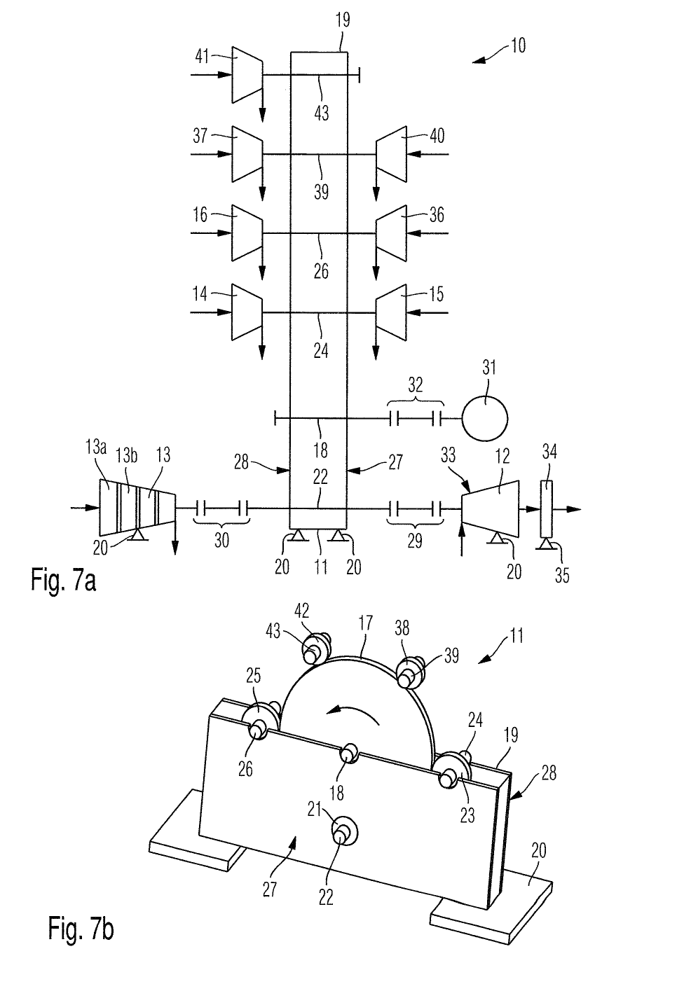

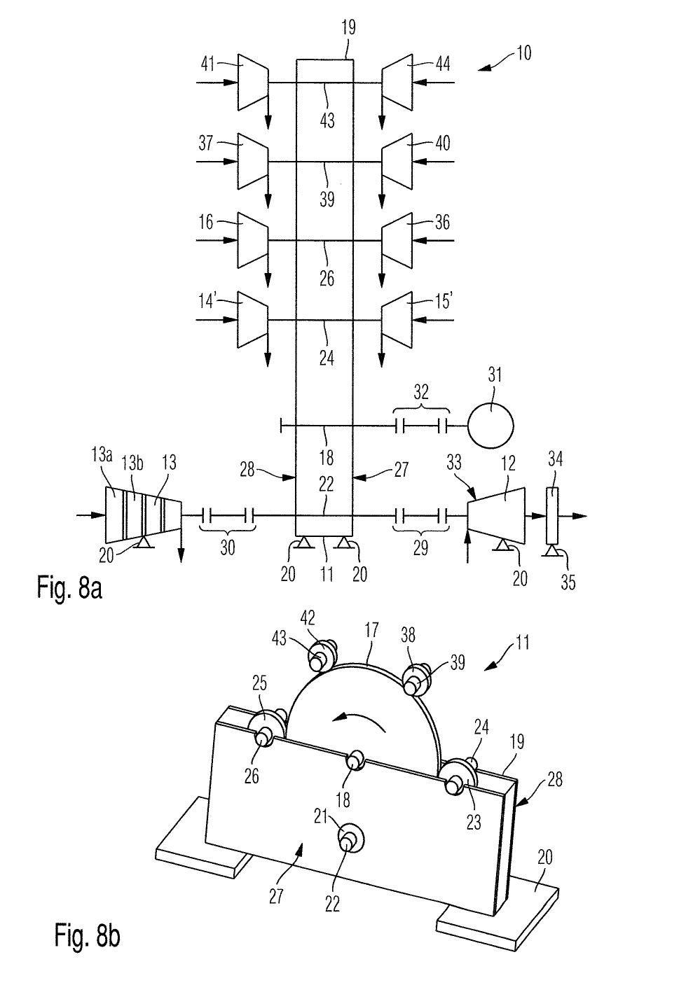

Further exemplary embodiments of the geared turbomachine 10 according to the invention are shown by FIG. 1a, 1b, FIG. 2a, 2b, FIG. 4a, 4b, FIG. 5a, 5b, FIG. 6a, 6b, FIG. 7a, 7b, and FIG. 8a, 8b, wherein in the following only details by which the further geared turbomachines 10 according to the invention differ from the geared turbomachine 10 of FIG. 3a, 3b are discussed.

With the geared turbomachine 10 of FIG. 1a, 1b only one geared compressor 14 is present, which is connected to a pinion shaft 24 in a rotationally fixed manner.

With the geared turbomachine 10 of FIG. 2a, 2b a total of two geared compressors 14, 15 are present, which are connected to the pinion shaft 24 in a rotationally fixed manner. Accordingly, the two geared compressors 14 and 15 are connected to the second pinion shaft 24 of the gear unit 11 in a rotationally fixed manner on different sides of the gear unit housing 10.

With the geared turbomachine 10 of FIG. 4a, 4b, a total of four geared compressors 14, 15, 16, and 36 are present, which are connected to two pinion shafts 24 and 26 in a rotationally fixed manner. Accordingly, the two geared compressors 14 and 15 are connected to the second pinion shaft 24 on different sides of the gear unit housing 10 and the two geared compressors 16, 36 are connected to the third pinion shaft 26 of the gear unit 11 on different sides of the gear unit housing 10 in a rotationally fixed manner.

In the exemplary embodiment of FIGS. 5 and 5b and FIGS. 6a and 6b the gear unit 11 of the geared turbomachine 10 each comprises a fourth pinion shaft 39, with which in the exemplary embodiment of FIG. 5a, 5b a fifth geared compressor 37 and in the exemplary embodiment of FIG. 6a, 6b additionally a sixth geared compressor 40 is connected in a rotationally fixed manner. The fourth pinion shaft 39 in this case is arranged together with the pinion mounted on the same approximately in the 12 o'clock position of the large gear 17, wherein the pinion 38 mounted on the fourth pinion shaft 39 meshes with the large gear 17 on this position on the circumference of the same.

Two further exemplary embodiments of geared turbomachines 10 are shown by FIG. 7a, 7b and FIG. 8a, 8b, wherein in FIG. 7a, 7b and FIG. 8a, 8b a fifth pinion shaft 43 each is present. In the exemplary embodiment of FIG. 7a, 7b, a seventh geared compressor 41 is connected to this fifth pinion shaft 43 in a rotationally fixed manner, wherein in FIG. 8a, 8b the seventh geared compressor 41 and additionally an eighth geared compressor 44 is connected to the fifth pinion shaft 43 in a rotationally fixed manner. As is evident from FIG. 7b, 7b, the fourth pinion shafts 39 in these exemplary embodiments is arranged approximately in the 1 o'clock position and the fifth pinion shafts 43 approximately in the 11 o'clock position of the large gear 17, wherein the corresponding pinions 38, 42 mesh with the large gear 17 in these positions on the circumference of the same.

Independently of the aforementioned embodiment versions it is possible that the first pinion shaft 22 meshes with the large gear via the pinion approximately in the 6 o'clock position or approximately in the 9 o'clock position or approximately in the 11 o'clock position or approximately in the 12 o'clock position or approximately in the 1 o'clock clock position or approximately in the 3 o'clock position of the large gear and that the at least one further pinion shaft 24, 26, 39, 43 meshes with the large gear in at least one of the free positions of the large gear via the respective pinions.

In addition to the aforementioned embodiment versions it is optionally also possible that in each case between the pinion shafts 22, 24, 26, 39, 43 and the large gear 17 at least one intermediate gear with intermediate gear shaft each which is not shown is arranged and connected to the pinion shafts 22, 24, 26, 39, 43 and the large gear 17 in a rotationally fixed manner.

In particular areas of application of geared turbomachines it can also be that instead of at least one of the second drive units 14, 15, 16, 36, 37 40, 41 44 at least one further drive unit 14′, 15′, 16′, 36′, 37′, 40′, 41′, 44′ is connected to one of the pinion shafts 24, 26, 39, 43 in a rotationally fixed manner. The further drive unit could be an expander, a motor or even a gas or steam turbine.

In addition, for running up the geared turbomachine the generator/motor 31 can initially function as drive unit and only following the running up of the motor/generator 31 function as output unit in generator mode.

Under special circumstances it can also be possible that the drive unit is embodied as a gas turbine, expander or motor.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A geared turbomachine, comprising:
a gear unit; having a central large gear with a large gear shaft and at least two pinions with at least two pinion shafts that mesh with the central large gear;
at least one drive unit; and
at least two output units, integrated into a machine train;
a drive unit coupled to a first pinion shaft of the gear unit on a first side via a first clutch; and
a first output unit configured as a main compressor configured to use mechanical drive power provided by the drive unit to compress a first process gas, the first output unit coupled to the first pinion shaft of the gear unit on a second side opposite the first side via a second clutch,
wherein the first output unit is directly operationally connected to the drive unit when the first clutch is closed and the second clutch is closed,
wherein at least one second output unit is configured as geared compressor that uses the mechanical drive power provided by the drive unit, the at least one second output unit connected to at least one further pinion shaft of the gear unit in a rotationally fixed manner.

2. The geared turbomachine according to claim 1, wherein the drive unit is a steam turbine configured to provide mechanical drive power as steam is expanded.

3. The geared turbomachine according to claim 2, wherein the drive unit is a steam turbine comprising an axial exhaust steam casing.

4. The geared turbomachine according to claim 2, wherein a condenser of the drive unit is positioned, seen in a direction of a longitudinal axis of a steam turbine, next to a foundation table supporting a steam turbine.

5. The geared turbomachine according to claim 4, wherein the condenser is positioned next to the foundation table supporting the steam turbine on separate supports.

6. The geared turbomachine according to claim 1, wherein the main compressor has multiple stages.

7. The geared turbomachine according to claim 6, wherein the main compressor is a radial compressor.

8. The geared turbomachine according to claim 7, wherein downstream of a front compressor stage of the main compressor an intercooler is positioned to reduce a volume and a temperature of a compressed second process gas.

9. The geared turbomachine according to claim 1, wherein the main compressor is configured as axial compressor with at least one radial final stage.

10. The geared turbomachine according to claim 9, wherein an intercooler is positioned downstream after axial stages of the main compressor and before entry in the at least one radial final stage to reduce a volume and a temperature of a compressed first process gas.

11. The geared turbomachine according to claim 1, wherein the first pinion shaft meshes with the central large gear at one of approximately a 6 o'clock position, approximately in the 9 o'clock position, approximately in the 11 o'clock position, approximately in the 12 o'clock position, approximately in the 1 o'clock position, and approximately in the 3 o'clock position of the central large gear and in that the at least one further pinion shaft meshes with the central large gear via the respective pinion in at least one free position of the central large gear.

12. The geared turbomachine according to claim 1, wherein two second output units are configured as geared compressors, wherein these two geared compressors on opposite sides of the gear unit are connected to a second pinion shaft of the gear unit in a rotationally fixed manner.

13. The geared turbomachine according to claim 1, wherein three second output units are configured as geared compressors, wherein two geared compressors on opposite sides of the gear unit are connected to a second pinion shaft of the gear unit, and a third geared compressor is connected to a third pinion shaft of the gear unit in a fixed manner.

14. The geared turbomachine according to claim 1, wherein four second output units are configured as geared compressors, wherein two geared compressors on opposite sides of the gear unit are connected to a second pinion shaft of the gear unit and two further geared compressors on opposite sides of the gear unit are connected to a third pinion shaft of the gear unit in a rotationally fixed manner.

15. The geared turbomachine according to claim 1, wherein five second output units are configured as geared compressors, wherein two geared compressors on opposite sides of the gear unit are connected to a second pinion shaft of the gear unit and two further geared compressors on opposite sides of the gear unit are connected to a third pinion shaft in a rotationally fixed manner, and wherein a fifth geared compressor is connected to a fourth pinion shaft of the gear unit in a rotationally fixed manner.

16. The geared turbomachine according to claim 1, wherein six second output units are configured as geared compressors, wherein two geared compressors on opposite sides of the gear unit are connected to a second pinion shaft of the gear unit, two further geared compressors on opposite sides of the gear unit are connected to a third pinion shaft of the gear unit and again two further geared compressors on opposite sides of the gear unit are connected to a fourth pinion shaft of the gear unit in a rotationally fixed manner.

17. The geared turbomachine according to claim 1, wherein seven second output units are configured as geared compressors, wherein two geared compressors on opposite sides of the gear unit are connected to a second pinion shaft of the gear unit, two further geared compressors on opposite sides of the gear unit are connected to a third pinion shaft of the gear unit in a rotationally fixed manner, and again two further geared compressors on opposite sides of the gear unit are connected to a fourth pinion shaft of the gear unit in a rotationally fixed manner, and wherein a seventh geared compressor is connected to a fifth pinion shaft of the gear unit in a rotationally fixed manner.

18. The geared turbomachine according to claim 1, wherein eight second output units are configured as geared compressors, wherein two geared compressors on opposite sides of the gear unit are connected to a second pinion shaft of the gear unit, two further geared compressors on opposite sides of the gear unit are connected to a third pinion shaft of the gear unit, again two further geared compressors on opposite sides of the gear unit are connected to a fourth pinion shaft of the gear unit in a rotationally fixed manner and again two further geared compressors on opposite sides of the gear unit are connected to a fifth pinion shaft of the gear unit in a rotationally fixed manner.

19. The geared turbomachine according to claim 1, wherein at least one further drive unit is connected to one of the pinion shafts in a rotationally fixed manner.

20. The geared turbomachine according to claim 19, wherein the at least one further drive unit is one of an expander, a motor, a gas turbine, and steam turbine.

21. The geared turbomachine according to claim 1, wherein a generator/motor is coupled to the large gear shaft of the central large gear via a clutch.

22. The geared turbomachine according to claim 21, wherein during a start-up the geared turbomachine the generator/motor initially functions as drive unit and wherein after the start-up the generator/motor in a generator mode functions as output unit.

23. The geared turbomachine according to claim 1, wherein at least 50% of a total power of the machine train is provided by the main compressor.

24. The geared turbomachine according to claim 1, wherein between the pinion shafts and the central large gear at least one intermediate gear with an intermediate gear shaft is arranged and connected to the pinion shafts and the central large gear in a rotationally fixed manner.
